(19) United States
(12) Patent Application Publication
(10) Pub. No.: US 2015/0083411 A1
(43) Pub. Date: Mar. 26, 2015

(54) AUTOMATED SYSTEMS AND METHODS FOR PRODUCTION OF GAS FROM GROUNDWATER AQUIFERS

(71) Applicant: Oborn Environmental Solutions, LLC, Lake Stevens, WA (US)

(72) Inventors: Charles Benjamin Barnes Oborn, Lake Stevens, WA (US); Gary Farnsworth Player, Cedar City, UT (US)

(21) Appl. No.: 14/495,573

(22) Filed: Sep. 24, 2014

Related U.S. Application Data
(60) Provisional application No. 61/960,710, filed on Sep. 24, 2013.

(51) Int. Cl. C02F 1/20; B01D 53/26; E21B 43/40; B01D 19/00

(52) U.S. Cl. CPC C02F 1/20; B01D 19/0063; B01D 53/268; B01D 53/263; E21B 43/40; C02F 2103/06
USPC 166/266; 96/156; 96/173; 96/174; 96/4; 166/52

(57) ABSTRACT

Automated systems and methods of extracting gas from groundwater aquifers are provided.

### CROSS-REFERENCE TO RELATED APPLICATION

This application claims the benefit of U.S. Provisional Application No. 61/960,710 filed Sep. 24, 2013, incorporated by reference herein.

### FIELD OF THE INVENTION

The present invention relates to automated methods and systems for extracting dissolved gas from groundwater aquifers.

### BACKGROUND

Groundwater aquifers are subsurface layers of water-bearing permeable rock, gravel, sand or silt. Many groundwater aquifers contain methane gas dissolved in the water and the water is sometimes referred to as brine due to its large salt content. The methane is dissolved in the water when the water is underground due to the hydrostatic pressure exerted by the water and layers of rock, etc. above the water. The water and dissolved methane in aquifers can be accessed by drilling wells into the aquifer. When the water is brought to the surface, the methane gas comes out of solution due to the reduced pressure and can be recovered. Groundwater aquifers therefore are a source of methane, which is a major component of natural gas.

Tapping groundwater aquifers as a source of methane is not an ideal option for obtaining natural gas. Aquifers have smaller amounts of gas compared to conventional sources and there are problems associated with the extraction of gas from aquifers. One of the major problems associated with production of gas from aquifers is that large volumes of brine must he tapped to obtain substantial amounts of gas. Extracting large volumes of brine creates significant environmental problems. One problem associated with the extraction of large amounts of water from an aquifer is subsidence, i.e., the sinking or caving in of the land surface. Another problem is the disposal of the brine. Discharging large amounts of brine onto the land surface, where it may eventually enter rivers and streams, can have a considerable environmental impact. Surface discharge is tightly regulated by government authorities. Therefore the economics of using groundwater as a source of natural gas are less attractive than conventional gas sources.

However, groundwater aquifers provide a great potential as a source of natural gas if the subsidence and brine disposal issues can be mitigated to make production commercially feasible. Therefore, there is a need in the art for methods of extracting methane from groundwater aquifers that are commercially feasible and mitigate the environmental impacts of the large amounts of brine produced in the process. The present disclosure addresses these and other needs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect the present disclosure provides an automated system for extracting gas from a groundwater aquifer, the system comprising: a vessel to facilitate the separation of a dissolved gas from a fluid, thereby producing a gas stream and a fluid stream; one or more compressors to receive the gas stream and compress the gas; one or more filtration units; one or more sensors to measure one or more operational parameters of the system; one or more sensors to measure one or more chemical or physical properties of the fluid, the gas stream, and the fluid stream; and one or more controllers programmable to receive input from the sensors, regulate the flow of the fluid, the gas stream, and the fluid stream through the system, and co-ordinate the operation of the system to produce gas and introduce the fluid or fluid steam into the aquifer. In some embodiments, the gas is methane gas.

In one aspect of the present disclosure, methods for extracting gas from groundwater aquifers using an automated system are provided.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flow diagram illustrating an overview of the process of extracting gas from groundwater aquifers utilizing a representative embodiment of the system of the present disclosure.

FIG. 2 illustrates a perspective view of a representative embodiment of the system of the present disclosure.

### DETAILED DESCRIPTION

In one aspect of the present disclosure, an automated system for extracting gas from groundwater aquifers is provided. As used herein, the term “automated system” refers to an integrated system in which some or all of the operations may be controlled by one or more programmable logic controllers. The automated system of the present disclosure comprises pieces of equipment, pipes, valves, sensors, and one or more controllers. The automated system is integrated to monitor a variety of parameters and to control the processes within the system, as further described below. Controllers may receive input from sensors distributed throughout the system or input from an operator of the system. In some embodiments, the automated system may comprise alarm systems to be activated if certain critical parameters are exceeded, and may also comprise safety shut-off features. The automated system may be programmed for continuous automatic operation. The automated system may be programmed to allow for certain processes to be manually controlled.

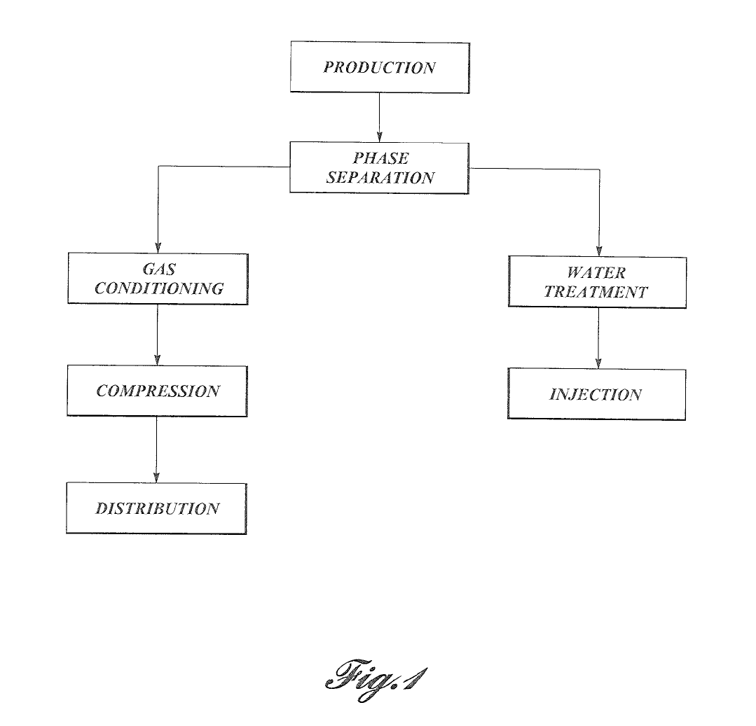

A flow diagram of the process of extracting gas from groundwater aquifers utilizing a representative embodiment of the present disclosure is illustrated in FIG. 1. Referring to FIG. 1, in one embodiment, the system comprises seven modules: production; phase separation; gas conditioning; gas compression; gas distribution; fluid treatment; and injection. As used herein, the term “module” refers generally to a collection of pieces of equipment used for a particular purpose.

As described more fully below, the modules are interconnected by a series of pipes and valves and their operation is coordinated by means of one or more programmable logic controllers. Briefly, in operation, the system performs the following processes: (1) production—extracting fluid from an aquifer; (2) separation—separating dissolved gas from the fluid; (3) gas conditioning—removing solid particulate matter and moisture from the gas; (4) gas compression—pressurizing the gas to facilitate distribution; (5) distribution—transferring the gas to a pipeline, tanker, etc. for distribution; (6) fluid treatment—filtering and treating the fluid to make it suitable to return to the aquifer; and (7) injection—returning the fluid to the original aquifer.

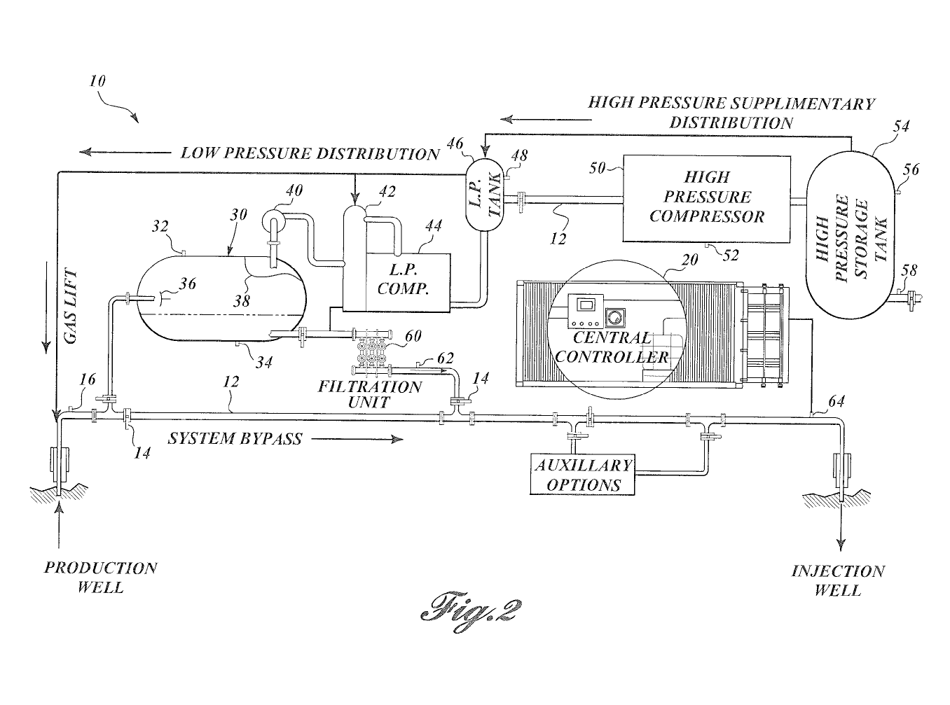

A representative embodiment of the system of the present disclosure is illustrated in FIG. 2. FIG. 2 illustrates an overview of the system 10. The operation of the system 10 is managed and controlled by one or more programmable logic controllers (“PLC”) 20.

The system 10 is constructed and arranged to process fluid extracted from a groundwater aquifer. The fluid is extracted by way of a well drilled into the aquifer. The well is referred to in FIG. 2 as a “Production Well.” The fluid is a mixture of water, which may be saline, methane gas, and possibly other gases and liquid hydrocarbons such as oil. The fluid is in an anaerobic state when in the well. The system 10 is an closed system designed to maintain the fluid in an anaerobic state. Maintaining the fluid in an anaerobic state is desirable to prevent the growth of bacteria in the fluid during processing to avoid the introduction of algae and bacteria into the aquifer when the fluid is reintroduced into the aquifer.

The system 10 comprises a series of pipes 12 to transfer gas and fluid through the system. The pipes are typically PVC (polyvinylchloride) or ABS (acrylonitrile butadiene styrene). The system 10 further comprises a number of valves 14. The valves 14 can be used to regulate the flow of fluid and gas through the system 10. The pipes and valves shown in FIG. 2 are for illustration purposes only and aren't limited to the numbers and placements shown in the drawing.

The system 10 further comprises a number of sensors. The sensors are placed throughout the system 10 and are used to monitor one or more operational parameters of the system 10, for example, flow and/or pressure, and one or more chemical or physical properties of the fluid and/or gas, for example temperature, dissolved oxygen, pH, conductivity, total dissolved solids, and humidity, as applicable.

Referring to FIG. 2, in operation, the system 10 receives fluid from the Production Well. A group of sensors 16, may be used to measure, for example, flow rate, pressure, and temperature of the fluid coming out of the Production Well. The fluid is transferred into a vessel 30. In some embodiments, the fluid is filtered to remove particulate matter, such as residual sand and silt, and any bacterial matter, before the fluid is transferred to the vessel 30. In some embodiments, the vessel 30 is a two-phase separator vessel designed to separate the fluid into gas and liquid phases. In some embodiments, the vessel 30 is a three-phase separator vessel designed to separate the fluid into gas, liquid, and oil phases.

The vessel 30 is sized, and the amount of the fluid introduced into the vessel 30 is controlled, so as to allow sufficient space within the vessel 30 for the gas dissolved in the fluid to be released from the fluid. The pressure in the vessel 30 is maintained at about 50 pounds per square inch (“psi”) or less. The fluid is retained in the vessel 30 for an amount of time, at least three seconds or more, to allow the fluid to separate into gas, liquid, and if present, oil phases. The separate phases are illustrated in FIG. 2 by a broken line, which denotes the gas phase above the line and the fluid (liquid) phase below the line.

A group of sensors 32 may be used to measure, for example, pressure, temperature, and humidity of the gas phase in the vessel 30. A group of sensors 34 may be used to measure, for example, temperature, dissolved oxygen, pH, and conductivity of the fluid phase in the vessel 30.

In some embodiments, the vessel 30 may include a diffuser 36. The fluid is pumped into the vessel 30 above the level of the fluid phase. The diffuser 36 is placed near the stream of fluid entering into the vessel 30 and is used to facilitate the dissolution of the gas from the fluid. The diffuser 36 may be a wall, dish or other surface. Spraying the fluid against a diffuser 36 decreases surface tension and aids in the dissolution of gas from the fluid, thereby reducing the time for dissolution and increasing gas yield. However, in some embodiments, the fluid will retain some dissolved gas.

As further explained below, following phase separation, the gas is conditioned to meet government and industry requirements, and the fluid is treated to prepare the fluid for reintroduction into the aquifer.

Gas Conditioning. The gas industry has certain quality standards that must be met prior to distribution of natural gas. The requirements include that the gas must be free of particulate solids and liquid water, and contain only minimal amounts of water vapor. To meet these standards, in some embodiments, the vessel 30 may include a membrane 38 to aid in the removal of water from the gas. As the gas moves through the membrane 38, water vapor present in the gas is liquefied into water and is removed from the gas. Although not shown in FIG. 2, the system 10 may also include filters to remove particulates, and means to remove hydrogen sulfide, carbon dioxide, and other undesirable elements from the gas.

A low pressure blower 40 is used to move the gas from the vessel 30 to a dehydration unit 42. The dehydration unit 42 is used to remove residual water vapor from the gas. A suitable dehydration unit is one that uses glycol as the desiccant.

After dehydration, the gas may be transferred to a low pressure compressor 44 to compress the gas to about 200-250 psi, and then to a low pressure holding tank 46. The low pressure holding tank 46 may include a sensor 48 to measure the pressure in the tank 46.

Gas stored in the holding tank 46 can be used to operate the system 10. For example, in some instances, when the fluid in a well does not contain enough natural pressure to force the fluid to the surface, a gas lift can be used. A gas lift injects compressed gas into the well, which causes the fluid to move to the surface. Gas from the holding tank 46 can be used as a gas lift, if needed, to bring the fluid from the Production Well to the surface. Gas from the holding tank 46 can also be used to regenerate glycol in the dehydration unit 42, and to operate various engines within the system.

When gas in the holding tank 46 exceeds the amount required to meet operational needs of the system 10, the excess gas may be transferred to a high pressure compressor 50. Alternatively, the gas may be transferred directly from the dehydration unit 42 to the high pressure compressor 50. The high pressure compressor 50 may include a group of sensors 52 to measure flow, temperature, and pressure of the gas. The high pressure compressor 50 may pressurize the gas, for example, to about 1,000 to 1200 psi. The gas may then be transferred to a high pressure storage tank 54. The high pressure storage tank may include a sensor 56 to measure the pressure in the storage tank 54. When needed, the gas is transferred from the high pressure storage tank 54 to a distribution means. As the gas flows from the storage tank 54 via a pipe, a group of sensors 58 measure, for example, flow, temperature, pressure and humidity of the gas to ensure it complies with industry and government requirements.

Fluid Treatment. The fluid may be transferred from the vessel 30 and passed through a filtration unit 60 to remove particulate matter, such as residual sand and silt, and any bacterial matter. As the fluid passes out of the filtration unit via a pipe, a group of sensors 62 measures, for example, flow, pressure and dissolved oxygen. It is necessary that the fluid be substantially free of dissolved oxygen to prevent formation of algae and other bacterial growth. The chemical measurements of the fluid after gas separation are compared to the initial measurements taken when the fluid was extracted from the Production Well. If chemical treatment is necessary to restore the initial values, for example pH, then chemicals can be added to the fluid through an injection port 64. After any necessary treatment, the fluid is then re-injected into the aquifer via an Injection Well. Maintaining or restoring the chemical and physical properties of fluid that has been processed through the system 10 to be the same or approximately the same as the initial values, before reintroduction of the fluid into the original aquifer, lessens the environmental impact that may be caused by removing and reintroducing fluid into the same aquifer.

As shown in FIG. 2, in some embodiments, the system 10 also may include a system bypass feature constructed to receive the fluid from the groundwater aquifer and return the fluid to the groundwater aquifer without further processing the fluid, for example, without separating the fluid into a gas phase and a fluid phase. If the flow rate or pressure of the fluid coming out of the well are greater than can be accommodated by the vessel 30, and/or if the fluid does not meet certain predetermined standards, the fluid may be directed into the bypass route, where it will then be re-injected into the aquifer via the Injection Well.

Except for the one or more programmed PLC(s), the system of the present disclosure utilizes standard, commercially available equipment. The system of the present disclosure operates at relatively low pressure. This minimizes risk associated with high pressure operations, and allows for the use of equipment that is approved for use at lower pressures, thereby reducing equipment costs. As discussed above, the system also utilizes gas that is produced by the system to operate the system, thereby reducing operational costs. The one or more PLC(s) are programmed to co-ordinate the various modules of the system to minimize the amount of fluid present on the surface at any one time and to maximize efficiencies within the system.

Therefore, the system of the present disclosure provides a process that operates at low pressure, creates efficiencies, and mitigates the environmental impact associated with the production of gas from groundwater, for example, subsidence and surface disposal of large quantities of brine, thereby making the use of groundwater as a source of natural gas economically viable and commercially feasible.

As discussed in detail above, in one aspect the present disclosure provides an automated system for extracting gas from a groundwater aquifer, the system comprising: a vessel to facilitate the separation of a dissolved gas from a fluid, thereby producing a gas stream and a fluid stream; one or more compressors to receive the gas stream and compress the gas; one or more filtration units; one or more sensors to measure one or more operational parameters of the system; one or more sensors to measure one or more chemical or physical properties of the fluid, the gas stream, and the fluid stream; and one or more controllers programmable to receive input from the sensors, regulate the flow of the fluid, the gas stream, and the fluid stream through the system, and co-ordinate the operation of the system to produce gas and introduce the fluid or fluid steam into the aquifer. As used herein, the term “fluid” refers to the fluid extracted from an aquifer before it is processed by the automated system. As used herein, the term “fluid stream” refers to the fluid produced in the vessel after gas has been separated from the fluid. In some embodiments, the gas is methane gas.

In some embodiments, the one or more compressors is constructed to compress the gas to a pressure of from about 200 pounds per square inch to about 250 pounds per square inch. In some embodiments, the one or more compressors is constructed to compress the gas to a pressure of from about 1000 pounds per square inch to about 1200 pounds per square inch.

In some embodiments, the one or more filtration units is constructed to remove particulate matter from the fluid or the fluid stream. In some embodiments, the one or more filtration units is constructed to remove bacterial matter from the fluid or the fluid stream. In some embodiments, the one or more filtration units is a chemical filter or a physical filter.

In some embodiments, the one or more sensors measures temperature, pressure, or rate of flow of the fluid, the gas stream or the fluid stream. In some embodiments, the one or more sensors measures pH, total dissolved solids, dissolved oxygen, or conductivity of the fluid or the fluid stream.

In some embodiments, the system further comprises a dehydration unit to remove water vapor from the gas stream. In some embodiments, the dehydration unit utilizes glycol as a desiccant to remove the water vapor.

In some embodiments, the vessel further comprises a diffuser constructed to facilitate the dissolution of gas from the fluid. In some embodiments, the vessel further comprises a membrane constructed to remove water vapor from the gas.

In some embodiments, the system further comprises one or more tanks to hold the compressed gas.

In some embodiments, the system further comprises a bypass system constructed to receive the fluid from the groundwater aquifer and return the fluid to the groundwater aquifer without separating the dissolved gas from the fluid.

In some embodiments, the system further comprises a chemical port constructed to inject chemicals into the fluid stream to treat the fluid stream before the fluid steam is injected into the aquifer.

In some embodiments, the system is a closed system to maintain the fluid in an anaerobic state. As used herein, the term “closed system” means that the system is constructed so as to prevent exposure of the fluid or the fluid stream to air to prevent the growth of algae or bacteria in the fluid stream.

In one aspect of the present disclosure, methods for extracting gas from groundwater aquifers using an automated system are provided. The methods of the present disclosure comprise the steps of: (a) extracting fluid comprising fluid and dissolved gas from a groundwater aquifer; (b) measuring one or more chemical or physical properties of the fluid extracted from the aquifer; (c) transferring the fluid to a vessel; (d) retaining the fluid in the vessel for a period of time to allow dissolved gas to separate from the fluid; (e) compressing the gas; (f) filtering the fluid to remove sediment and bacteria from the fluid; (g) measuring one or more chemical or physical properties of the fluid after the dissolved gas is separated from the fluid; (h) treating the fluid such that one or more of the chemical or physical properties of the fluid is the same or approximately the same as the one or more chemical or physical properties measured in step (b); and (i) injecting the fluid into the aquifer of step (a); wherein steps (a) through (h) are coordinated and controlled by one or more programmable logic controllers.

The steps of the method are not limited to any order. For example, the fluid can be filtered when the fluid is extracted from the aquifer, before transfer to a vessel, or after the dissolved gas has been separated from the fluid, or both before transfer to a vessel and after separation.

In some embodiments, the methods of the present disclosure further comprise the step of: transferring the gas obtained from the phase separator to a dehydrator to remove water vapor from the gas.

In some embodiments, the methods of the present disclosure further comprise the step of: compressing the gas to a pressure of from about 200 pounds per square inch to about 250 pounds per square inch.

In some embodiments, the methods of the present disclosure further comprise the step of: compressing the gas to a pressure of from about 1000 pounds per square inch to about 1200 pounds per square inch.

In some embodiments, the methods of the present disclosure further comprise the step of: utilizing the compressed gas to facilitate extracting the fluid from the groundwater aquifer.

In some embodiments, the one or more steps of the method are performed in a closed, anaerobic system.

In some embodiments, the gas is methane.

While the invention has been illustrated and described, it will be appreciated that various changes can be made therein without departing from the spirit and scope of the invention.

We claim:

1. An automated system for extracting gas from a groundwater aquifer, the system comprising:
a vessel to facilitate the separation of a dissolved gas from a fluid, thereby producing a gas stream and a fluid stream;
one or more compressors to receive the gas stream and compress the gas;
one or more filtration units;
one or more sensors to measure one or more operational parameters of the system;
one or more sensors to measure one or more chemical or physical properties of the fluid, the gas stream, and the fluid stream; and
one or more controllers programmable to receive input from the sensors, regulate the flow of the fluid, the gas stream, and the fluid stream through the system, and coordinate the operation of the system to produce gas and introduce the fluid or fluid steam into the aquifer.

2. The automated system of claim 1, wherein the gas is methane gas.

3. The automated system of claim 1, wherein the one or more compressors is constructed to compress the gas to a pressure of from about 200 pounds per square inch to about 250 pounds per square inch.

4. The automated system of claim 1, wherein the one or more compressors is constructed to compress the gas to a pressure of from about 1000 pounds per square inch to about 1200 pounds per square inch.

5. The automated system of claim 1, wherein the one or more filtration units is constructed to remove particulate matter from the fluid or the fluid stream.

6. The automated system of claim 1, wherein the one or more filtration units is constructed to remove bacterial matter from the fluid or the fluid stream.

7. The automated system of claim 1, wherein the one or more filtration units is a chemical filter or a physical filter.

8. The automated system of claim 1, wherein the one or more sensors measures temperature, pressure, or rate of flow of the fluid, gas stream, or fluid stream.

9. The automated system of claim 1, wherein the one or more sensors measures pH, total dissolved solids, dissolved oxygen, or conductivity of the fluid or the fluid stream.

10. The automated system of claim 1, further comprising a dehydration unit to remove water vapor from the gas stream.

11. The automated system of claim 10, wherein the dehydration unit utilizes glycol as a desiccant to remove the water vapor.

12. The automated system of claim 1, wherein the vessel further comprises a diffuser constructed to facilitate the dissolution of gas from the fluid.

13. The automated system of claim 1, wherein the vessel further comprises a membrane constructed to remove water vapor from the gas.

14. The automated system of claim 1, further comprising one or more tanks to hold the compressed gas.

15. The automated system of claim 1, further comprising a bypass system constructed to receive the fluid from the groundwater aquifer and return the fluid to the groundwater aquifer without separating the dissolved gas from the fluid.

16. The automated system of claim 1, further comprising a chemical port constructed to inject chemicals into the fluid stream to treat the fluid stream before the fluid stream is injected into the aquifer.

17. The automated system of claim 1, wherein the system is a closed system to maintain the fluid in an anaerobic state.

18. A method of extracting gas from a groundwater aquifer using an automated system comprising the steps of:
(a) extracting fluid comprising fluid and dissolved gas from a groundwater aquifer;
(b) measuring one or more chemical or physical properties of the fluid extracted from the aquifer;
(c) transferring the fluid to a vessel;
(d) retaining the fluid in the vessel for a period of time to allow dissolved gas to separate from the fluid;
(e) compressing the gas;
(f) filtering the fluid to remove sediment and bacteria from the fluid;
(g) measuring one or more chemical or physical properties of the fluid after the dissolved gas is separated from the fluid;
(h) treating the fluid such that one or more of the chemical or physical properties of the fluid is the same or approximately the same as the one or more chemical or physical properties measured in step (b); and
(i) injecting the fluid into the aquifer of step (a); wherein steps (a) through (h) are coordinated and controlled by one or more programmable logic controllers.

19. The method of claim 18, further comprising the step of: transferring the gas to a dehydrator to remove water vapor from the gas.

20. The method of claim 18, further comprising the step of: compressing the gas to a pressure of from about 200 pounds per square inch to about 250 pounds per square inch.

21. The method of claim 18, further comprising the step of: compressing the gas to a pressure of from about 1000 pounds per square inch to about 1200 pounds per square inch.

22. The method of claim 18, further comprising the step of: utilizing the compressed gas to facilitate extracting the fluid from the groundwater aquifer.

23. The method of claim 18, wherein one or more steps arc performed in a closed, anaerobic system.

24. The method of claim 18, wherein the gas is methane.
